(19) United States
(12) Patent Application Publication
(10) Pub. No.: US 2026/0370026 A1
(43) Pub. Date: Nov. 19, 2026

(54) METHOD FOR PRODUCING ALL-SOLID-STATE BATTERY AND METHOD FOR RECOVERING CAPACITY OF ALL-SOLID-STATE BATTERY

(71) Applicant: TOYOTA JIDOSHA KABUSHIKI KAISHA, Toyota-shi (JP)

(72) Inventor: Yuki IKEDA, Toyota-Shi (JP)

(73) Assignee: TOYOTA JIDOSHA KABUSHIKI KAISHA, Toyota-shi (JP)

(21) Appl. No.: 19/370,489

(22) Filed: Oct. 27, 2025

(30) Foreign Application Priority Data
Nov. 25, 2024 (JP) 2024-204516

(51) Int. Cl. H02J 7/94; H01M 10/44

(52) U.S. Cl. CPC H02J 7/94; H01M 10/44

(57) ABSTRACT

An all-solid-state battery is subjected to CCCV charging at a set voltage VB in a charging step, and then stored. In a capacity recovery step, the stored all-solid-state battery is subjected to CCCV charging at a set voltage VR that is higher than the set voltage VB, and is maintained at the set voltage VR for a predetermined period. When CCCV charging is performed after storage at the set voltage VR higher than the set voltage VB used in the CCCV charging before storage, more lithium ions are extracted from the cathode of the all-solid-state battery than before storage. As a result, the capacity is recovered.

### CROSS-REFERENCE TO RELATED APPLICATION

This application claims priority to Japanese Patent Application No. 2024-204516 filed on Nov. 25, 2024. The disclosure of the above-identified application, including the specification, drawings, and claims, is incorporated by reference herein in its entirety.

### BACKGROUND

### 1. Technical Field

The present disclosure relates to methods for producing an all-solid-state battery and methods for recovering the capacity of an all-solid-state battery.

### 2. Description of Related Art

Japanese Unexamined Patent Application Publication No. 2023-135693 (JP 2023-135693 A) discloses a method for recovering the capacity of an all-solid-state battery. In JP 2023-135693 A, the capacity of an all-solid-state battery is recovered by performing constant current-constant voltage discharging down to zero (V) while superimposing a ripple current, and maintaining the voltage at zero (V) for a predetermined period or longer.

### SUMMARY

During transportation etc., an all-solid-state battery may be stored for a relatively long period of time. The stored all-solid-state battery has a reduced state of charge (SOC) due to self-discharge. Therefore, in the capacity recovery method disclosed in JP 2023-135693 A, it is necessary to first fully charge the stored all-solid-state battery, then perform constant current-constant voltage discharging down to zero (V) while superimposing a ripple current, and maintain the voltage at zero (V) for a predetermined period or longer. This method requires the step of discharging the electrical energy stored during charging, and depending on the discharge environment, there is a concern that energy may be wasted.

An object of the present disclosure is to enable capacity recovery of an all-solid-state battery after storage while reducing energy waste.

A method for producing an all-solid-state battery according to the present disclosure includes: a charging step of performing constant voltage charging on the all-solid-state battery at a first voltage; a step of storing the all-solid-state battery after the charging step is completed; and a capacity recovery step of performing constant voltage charging on the stored all-solid-state battery at a second voltage that is higher than the first voltage, and maintaining the all-solid-state battery at the second voltage for a predetermined period.

In this method, the all-solid-state battery is subjected to the constant voltage charging at the first voltage in the charging step, and is then stored. The all-solid-state battery has a reduced SOC and a reduced capacity due to self-discharge during storage. The capacity of the stored all-solid-state battery is recovered by the capacity recovery step of performing constant voltage charging at the second voltage that is higher than the first voltage, and maintaining the second voltage for the predetermined period. The all-solid-state battery with recovered capacity can subsequently be used to supply the electrical energy stored during the capacity recovery step, thereby reducing energy waste.

The step of storing the all-solid-state battery may include transporting the all-solid-state battery or an article equipped with the all-solid-state battery. The capacity that has decreased during transportation of the all-solid-state battery can be recovered when the all-solid-state battery is used.

The constant voltage charging in the capacity recovery step may be constant current-constant voltage charging. Performing the constant current-constant voltage charging can reduce the charging time.

A method for recovering the capacity of an all-solid-state battery according to the present disclosure is a method for recovering the capacity of an all-solid-state battery that has been stored after constant voltage charging at a first voltage. The method includes: performing constant voltage charging on the all-solid-state battery at a second voltage that is higher than the first voltage; and after the constant voltage charging, maintaining the all-solid-state battery at the second voltage for a predetermined period.

In this method, the all-solid-state battery that has been stored after constant voltage charging at the first voltage is subjected to constant voltage charging at the second voltage higher than the first voltage, and is maintained at the second voltage for the predetermined period, thereby recovering the capacity. The all-solid-state battery with recovered capacity can be used to discharge the electrical energy stored during the capacity recovery step to a load or for other purposes, thereby reducing energy waste.

The present disclosure enables capacity recovery of an all-solid-state battery after storage while reducing energy waste.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart illustrating an outline of a method for producing an all-solid-state battery according to an embodiment of the present disclosure;

FIG. 2 is a flowchart illustrating control of a capacity recovery method in a capacity recovery step;

FIG. 3 is a graph illustrating the results of capacity recovery of an all-solid-state battery; and

FIG. 4 is a graph illustrating the capacity retention rates during capacity recovery at various set voltages.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated.

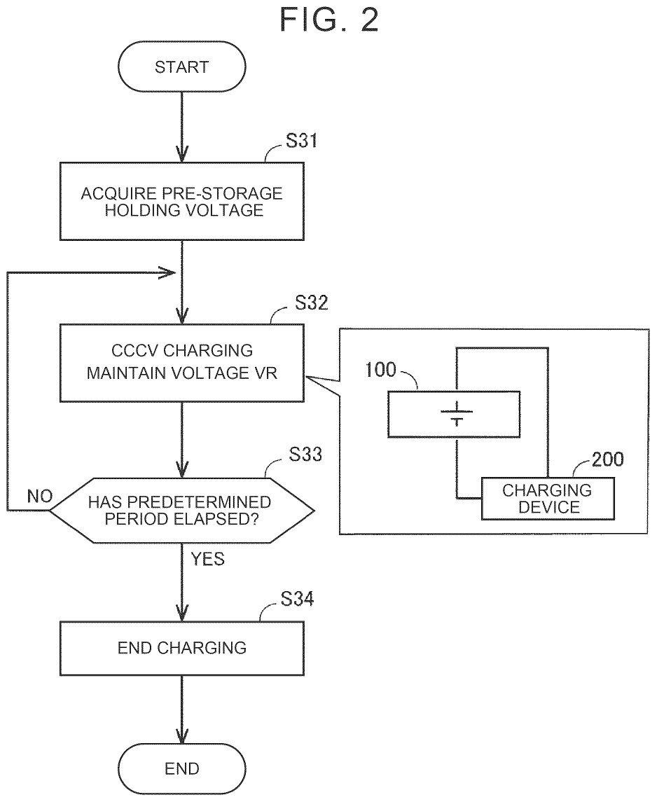

In the present embodiment, an all-solid-state battery 100 (see FIG. 2) is, for example, an NCA-LTO-based all-solid-state lithium-ion battery. A cathode active material of a cathode layer may include lithium nickel oxide such as NCA (LiNiₓCo_{y}Al_{z}O₂). An anode active material of an anode layer may include lithium titanate (LTO). A solid electrolyte layer may be a sulfide-based solid electrolyte. The all-solid-state battery 100 is manufactured by housing an all-solid-state battery element in an exterior member. The all-solid-state battery element is an element in which a cathode current collector, a cathode layer, a solid electrolyte layer, an anode layer, and an anode current collector are laminated in this order. A plurality of all-solid-state battery elements may be stacked and electrically connected in series, and housed in the exterior member.

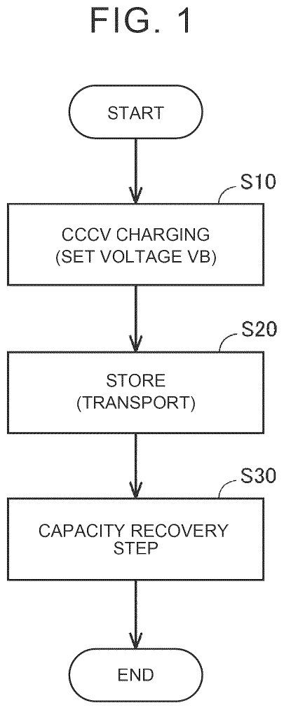

FIG. 1 is a flowchart illustrating an outline of a method for producing the all-solid-state battery 100 according to the embodiment. In step (hereinafter, the term “step” will be abbreviated as “S”) 10, a prepared all-solid-state battery is charged by constant current-constant voltage (CCCV) charging. In S10, the constant voltage value for the CCCV charging is VB. Hereinafter, this voltage will also be referred to as “set voltage VB.” Constant current (CC) charging is performed until the voltage of the all-solid-state battery reaches the set voltage VB. The C-rate may be, for example, 1C. When the all-solid-state battery 100 includes one all-solid-state battery element, the set voltage VB may be, for example, 2.7 (V).

Once the voltage of the all-solid-state battery 100 reaches the set voltage VB, constant voltage (CV) charging is performed. When the charging current falls to a predetermined value (such as 0.02C) or less while the charging voltage is maintained at the set voltage VB, charging of the all-solid-state battery 100 is completed. Charging may alternatively be completed when the duration of the CV charging exceeds a predetermined time. When charging of the all-solid-state battery 100 is completed in the charging step S10, the process proceeds to S20.

In S20, the charged all-solid-state battery 100 is stored. The storage period may be any period. For example, the storage period may be a transportation period during which a vehicle equipped with the charged all-solid-state battery 100 is transported by ship, and may be three to six months. S20 is a step of storing the all-solid-state battery 100.

In the subsequent step S30, capacity recovery of the stored all-solid-state battery is performed. The stored all-solid-state battery 100 has a reduced capacity due to self-discharge etc. In the present embodiment, the capacity of the all-solid-state battery 100 is recovered in the capacity recovery step S30.

FIG. 2 is a flowchart illustrating a capacity recovery method in the capacity recovery step S30. First, in S31, the pre-storage holding voltage of the all-solid-state battery 100 to be subjected to capacity recovery is acquired. The pre-storage holding voltage is the set voltage VB in S10 of FIG. 1. The set voltage VB is to an example of the “first voltage” in the present disclosure. For example, the set voltage VB is acquired from the history information of the all-solid-state battery 100 using a control device or a reading device, not shown. The history information of the all-solid-state battery 100 may be read from a two-dimensional code or a radio frequency identification (RFID) tag attached to the all-solid-state battery 100. The history information includes information on the set voltage VB. Alternatively, the set voltage VB may be acquired from a server that manages data on the set voltage VB, based on an identification (ID) of the all-solid-state battery 100 read from a two-dimensional code or an RFID tag.

A two-dimensional code or an RFID tag may be attached to a battery pack that includes the all-solid-state battery 100. When the all-solid-state battery 100 is mounted on a vehicle, the set voltage VB (pre-storage holding voltage) of the all-solid-state battery 100 may be acquired from a management server based on an identification number of the vehicle (for example, a vehicle identification number).

In S32, the all-solid-state battery 100 is charged by a charging device 200 using CCCV charging. In S32, the constant voltage value for the CCCV charging is VR. Hereinafter, this voltage will also be referred to as “set voltage VR.” The set voltage VR is higher than the set voltage VB. The set voltage VR corresponds to the “second voltage” in the present disclosure. In S32, CC charging is performed until the voltage of the all-solid-state battery 100 reaches the set voltage VR. The C-rate may be, for example, 0.5C. When the all-solid-state battery 100 includes one all-solid-state battery element, the set voltage VR may be, for example, 3.15 (V). Once the voltage of the all-solid-state battery 100 reaches the set voltage VR, CV charging is performed. In the CV charging, the voltage (charging voltage) supplied from the charging device 200 to the all-solid-state battery 100 is maintained at the set voltage VR regardless of the decrease in charging current.

In S33, it is determined whether a predetermined period has elapsed since the start of the CV charging at the set voltage VR. The predetermined period may be, for example, seven days. When the predetermined period has not elapsed, the voltage supplied from the charging device 200 to the all-solid-state battery 100 is continuously maintained at the set voltage VR. When the predetermined period has elapsed, the process proceeds to S34, where charging is completed, and the capacity recovery step ends.

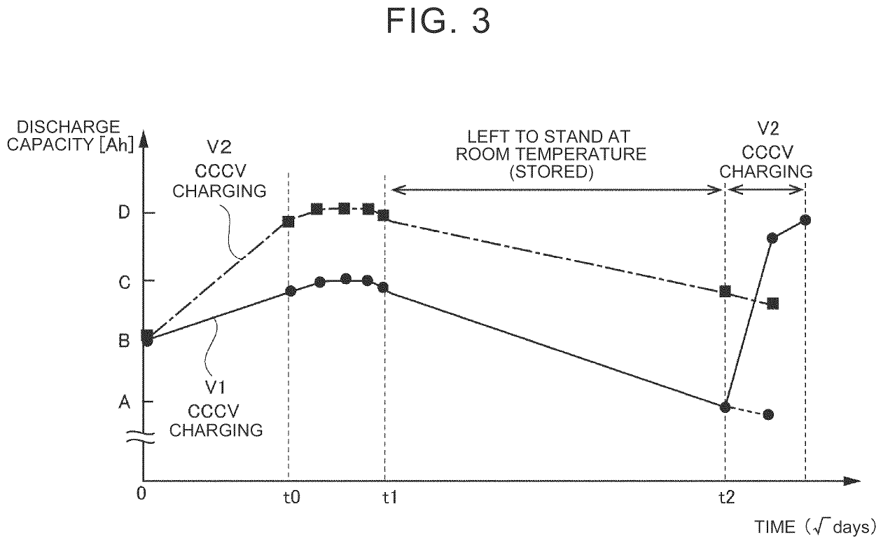

FIG. 3 is a graph illustrating the results of capacity recovery of the all-solid-state battery 100. In FIG. 3, the vertical axis represents the discharge capacity (Ah), and the horizontal axis represents time. The scale of the horizontal axis is the square root of the number of days (√days) (i.e., the number of days raised to the power of 0.5). In FIG. 3, the continuous line indicates the change in discharge capacity of an all-solid-state battery that was stored from time t1 to time t2 after an electrical durability evaluation involving CCCV charging at a set voltage V1 was performed following fabrication of the all-solid-state battery. The long dashed short dashed line indicates the change in discharge capacity of an all-solid-state battery that was stored from time t1 to time t2 after an electrical durability evaluation involving CCCV charging at a set voltage V2 was performed following fabrication of the all-solid-state battery. The set voltage V2 is higher than the set voltage V1. For example, the set voltage V2 is 3.15 (V), and the set voltage V1 is 2.7 (V).

In FIG. 3, the pre-storage CCCV charging (electrical durability evaluation) is performed in an environment of 60 °C. Specifically, CC charging is carried out at 1C until the set voltage is reached. Once the set voltage is reached, the charging is switched to CV charging at the set voltage. The set voltage is then maintained for seven days. The discharge capacity is obtained by discharging the all-solid-state battery. The discharging is performed at 25 °C and a C-rate of 0.5C. When the discharge current reaches 0.02C, the discharging is completed, and the discharge capacity is calculated based on the integrated value of the discharge current.

In FIG. 3, the electrical durability evaluation (CCCV charging) is performed five times. The discharge capacity between time t0 and time t1 corresponds to the full charge capacity of the all-solid-state battery. Upon completion of the fifth electrical durability evaluation at time t1, the all-solid-state battery was fully charged by CCCV charging at the set voltage and then stored. The period from time t1 to time t2 is the storage period. The storage period is six months.

At the end of the storage period (time t2), the discharge capacity of the all-solid-state battery stored after the CCCV charging at the set voltage V1 (hereinafter also referred to as “V1 all-solid-state battery”) had decreased from C (Ah), namely the discharge capacity at the start of the storage period (time t1), to A (Ah). The discharge capacity of the all-solid-state battery stored after the CCCV charging at the set voltage V2 (hereinafter also referred to as “V2 all-solid-state battery”) had decreased from D (Ah), namely the discharge capacity at the start of the storage period (time t1), to about C (Ah).

At time t2 (the end of the storage period), an electrical durability evaluation using CCCV charging at the set voltage V2 was performed on the V1 all-solid-state battery and the V2 all-solid-state battery. The CCCV charging was performed in an environment of 60 °C. Specifically, CC charging was carried out at 1C until the set voltage V2 is reached. Once the set voltage V2 was reached, the charging was switched to CV charging at the set voltage V2. The set voltage V2 was then maintained for seven days, and the discharge capacities of the V1 all-solid-state battery and the V2 all-solid-state battery were obtained. The post-storage electrical durability evaluation (CCCV charging at the set voltage V2) was performed two or more times.

As shown in FIG. 3, the discharge capacity of the V1 all-solid-state battery increased to about D (Ah) as a result of the electrical durability evaluation using CCCV charging at the set voltage V2. On the other hand, the discharge capacity of the V2 all-solid-state battery did not increase during the electrical durability evaluation using CCCV charging at the set voltage V2, and the capacity continued to decrease.

In FIG. 3, the dashed line for the V1 all-solid-state battery indicates the discharge capacity of the V1 all-solid-state battery during an electrical durability evaluation using CCCV charging at the set voltage V1. The discharge capacity of the V1 all-solid-state battery did not increase during the electrical durability evaluation using CCCV charging at the set voltage V1, and the capacity continued to decrease.

As shown in FIG. 3, when CCCV charging at the set voltage V2 is performed on the V1 all-solid-state battery, its discharge capacity increases, and the capacity of the V1 all-solid-state battery is recovered. On the other hand, when CCCV charging at the set voltage V2 is performed on the V2 all-solid-state battery and when CCCV charging at the set voltage V1 is performed on the V1 all-solid-state battery, their discharge capacities do not increase, and no capacity recovery occurs. This suggests that, when post-storage CCCV charging is performed at a set voltage higher than that used in the pre-storage CCCV charging, more lithium ions are extracted from the cathode of the all-solid-state battery than before storage, resulting in capacity recovery.

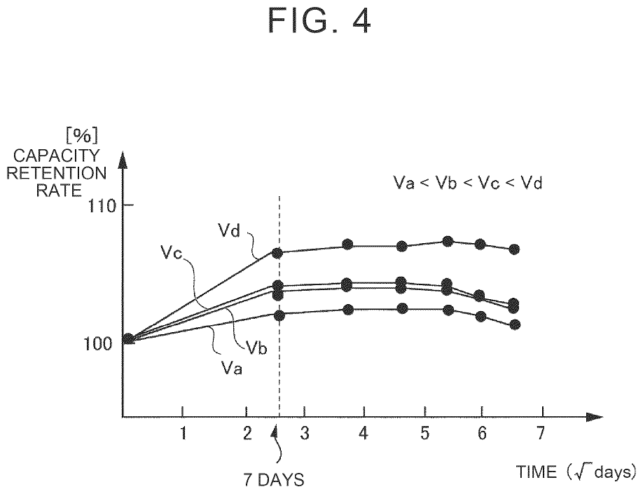

FIG. 4 is a graph illustrating the capacity retention rates during capacity recovery at various set voltages. In FIG. 4, the vertical axis represents the capacity retention rate, and the horizontal axis represents time. The scale of the horizontal axis is the square root of the number of days (√days) (i.e., the number of days raised to the power of 0.5). In FIG. 4, the capacity retention rates are shown with reference to the capacity at the end of the storage period (time t2 in FIG. 3) (the capacity retention rate at the end of the storage period is set to 100 (%)). CCCV charging is performed at set voltages Va to Vd. Once the set voltages Va to Vd are reached, they are continuously maintained. The horizontal axis represents the duration of CCCV charging that approximately corresponds to the time during which the set voltage is maintained. The magnitudes of the set voltages satisfy the following relationship: “Va<Vb<Vc<Vd.” The set voltage Va is higher than the set voltage of the pre-storage CCCV charging. The set voltage Vd is set to a voltage that does not cause overcharging of the all-solid-state battery.

As shown in FIG. 4, it is preferable that the set voltage for CCCV charging in the capacity recovery step be higher than the voltage for the pre-storage CCCV charging and within a range that does not cause overcharging of the all-solid-state battery. It is also preferable that the set voltages Va to Vd be maintained for at least seven days.

According to the present embodiment, the all-solid-state battery 100 is subjected to CCCV charging at the set voltage VB (first voltage) in the charging step (S10), and then stored (S20). The all-solid-state battery 100 has a reduced SOC and a reduced capacity due to self-discharge during storage. The capacity of the stored all-solid-state battery 100 is recovered by the capacity recovery step (S30, S31 to S34) of performing CCCV charging at the set voltage VR (second voltage) that is higher than the set voltage VB, and maintaining the set voltage VR for the predetermined period. The all-solid-state battery 100 with recovered capacity can subsequently be used to supply the electrical energy stored during the capacity recovery step, thereby reducing energy waste.

The step of storing the all-solid-state battery 100 may include transporting the all-solid-state battery 100 or an article equipped with the all-solid-state battery 100. The capacity that has decreased during transportation of the all-solid-state battery 100 can be recovered when the all-solid-state battery 100 is used.

According to the present embodiment, the all-solid-state battery 100 that has been stored after CCCV charging at the set voltage VB (first voltage) is subjected to CCCV charging at the set voltage VR (second voltage) that is higher than the set voltage VB. In the CCCV charging, the set voltage VR is maintained for the predetermined period (S32, S33), thereby recovering the capacity of the all-solid-state battery 100. The all-solid-state battery 100 with recovered capacity can be used to discharge the electrical energy stored during the capacity recovery step to a load or for other purposes, thereby reducing energy waste.

In the above embodiment, CCCV charging is performed in the charging step (S10) and the capacity recovery step (S30, S32). However, CV charging may alternatively be performed in the charging step and the capacity recovery step. In this case, CV charging is performed at the set voltage VB in the charging step, and CV charging is performed at the set voltage VR in the capacity recovery step.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A method for producing an all-solid-state battery, the method comprising:
a charging step of performing constant voltage charging on the all-solid-state battery at a first voltage;
a step of storing the all-solid-state battery after the charging step is completed; and
a capacity recovery step of performing constant voltage charging on the stored all-solid-state battery at a second voltage that is higher than the first voltage, and maintaining the all-solid-state battery at the second voltage for a predetermined period.

2. The method according to claim 1, wherein the step of storing the all-solid-state battery includes transporting the all-solid-state battery or an article equipped with the all-solid-state battery.

3. The method according to claim 1, wherein the constant voltage charging in the capacity recovery step is constant current-constant voltage charging.

4. A method for recovering capacity of an all-solid-state battery that has been stored after constant voltage charging at a first voltage, the method comprising:
performing constant voltage charging on the all-solid-state battery at a second voltage that is higher than the first voltage; and
after the constant voltage charging, maintaining the all-solid-state battery at the second voltage for a predetermined period.

5. The method according to claim 4, wherein the constant voltage charging at the second voltage is constant current-constant voltage charging.
